(19) United States
(12) Patent Application Publication
(10) Pub. No.: US 2023/0184459 A1
(43) Pub. Date: Jun. 15, 2023

(54) WATER HEATER AND A METHOD OF HEATING WATER UTILIZING MICROWAVE ENERGY

(71) Applicant: Michael K. McGuire, Austin, TX (US)

(72) Inventor: Michael K. McGuire, Austin, TX (US)

(21) Appl. No.: 18/078,210

(22) Filed: Dec. 9, 2022

Related U.S. Application Data
(60) Provisional application No. 63/288,757, filed on Dec. 13, 2021.

(51) Int. Cl. F24H 1/10; H05B 6/76; F24H 9/20; F24H 15/132; H05B 6/68; F24H 15/219

(52) U.S. Cl. CPC F24H 1/101; H05B 6/76; F24H 9/2028; F24H 15/132; H05B 6/68; F24H 15/219; F24H 2250/12

(57) ABSTRACT

A water heater and a method of heating water utilizing microwave energy are disclosed. The water heater includes an inlet pipe connecting tubular coils. The tubular coils overlap over one another in a pyramid-shape structure. The tubular coils include a microwave generator positioned adjacent to them. The water heater includes an insulation member that positions around the tubular coils. The tubular coils connect to an outlet pipe including a pressure relief valve and a switch. The inlet pipe supplies cold water to the tubular coils. The microwave generator produces microwave energy directed at the tubular coils. The microwave energy penetrates into the tubular coils and heats up the water. The insulation member reflects back the microwave energy into the tubular coils and ensures there is no loss of energy. The hot water flows through the outlet pipe.

### RELATED APPLICATIONS AND CLAIM FOR PRIORITY

The present application claims priority to U.S. Provisional Application No. 63/288,757 filed Dec. 13, 2021, titled “A WATER HEATER AND A METHOD OF HEATING WATER UTILIZING MICROWAVE ENERGY” with Attorney Docket No. MCGM001USP, which is incorporated herein by its entirety and referenced thereto.

### FIELD OF INVENTION

The present invention generally relates to an apparatus for heating liquid. More specifically, the present invention relates to a water heater for heating liquid such as water utilizing microwave energy.

### BACKGROUND OF INVENTION

Generally, water heaters are used to heat the water for domestic or industrial use. Typical water heater includes a large tank such as 40 or 50 gallons, for example. The (cold) water is first heated and then dispensed. The cold water that flows into the tank is heated, which requires the tank to be reheated. Reheating little or no water requires a large amount of energy that may have no immediate use.

Water heaters utilizing several techniques to heat water have been disclosed in the past. One such example is disclosed in a U.S. Pat. No. 7,465,907, entitled, “Microwave boiler and hot water heater” (“the '907 Patent”). The '907 Patent discloses a microwave water heater, which utilizes a triple plenum design with bi-planar cross-flow to provide uniformly heated water for both baseboard room heating and hot tap water, is adaptable to existing heating/plumbing systems and is readily expandable.

Another example is disclosed in a U.S. Pat. No. 9,351,611, entitled “Portable water heater” (“the '611 Patent”). The '611 Patent discloses a portable water heater including a housing. A base mounts to the housing. The base includes a plurality of base members that pivotably and/or slidably mounts to the base. At least one thermal source is disposed within the housing. The thermal source is configured to produce thermal energy in the housing. A thermal transfer conduit is disposed within the housing.

Another example is disclosed in a U.S. Pat. No. 4,152,567, entitled, “Microwave water heater” (“the '567 Patent”). The '567 Patent discloses a microwave water heater that provides a new and improved instantaneous hot water heating apparatus. The hot water heating apparatus utilizes electromagnetic energy to produce hot water. The invention consists of a source of electromagnetic energy, a resonant cavity, a fluid flow sensor means and a temperature sensor means. A flow sensor means controls the electromagnetic energy source as cold water is supplied from a conventional water supply system into the electrically isolated resonant cavity. Water is heated in the cavity as it moves through the cavity to the hot water outlet fixture. A thermostat may be provided in series with the flow sensor means to limit the output water temperature.

The above discussed disclosures provide a variety of ways of heating water. However, the existing water heaters have few disadvantages. For instance, there is a loss of heat radiated from the pipes, tubes and conduits carrying the heated water. Further, the existing water heaters consume a lot of electricity, which increases the cost for operating them.

Therefore, there is a need in the art to provide a unique way of heating water for domestic and light industrial use, the heating water that is capable of heating water with no heat loss and minimizes operational cost.

### SUMMARY

It is an object of the present invention to provide a unique water heater and that avoids the drawbacks of known water heaters.

It is another object of the present invention to provide a water heater for heating water utilizing microwave energy with minimum or no heat/energy loss.

It is another object of the present invention to provide a water heater that can be manufactured easily.

It is another object of the present invention to provide a water heater that is constructed using a three-dimensional (3D) printer with a very tightly coiled tube arrangement wrapped one coil overlapping the other coil in a pyramid type shape.

In order to achieve one or more objects, the present invention presents a water heater for heating water utilizing microwave energy. The water heater includes an inlet pipe connecting tubular coils. The tubular coils overlap over one another in a pyramid-shape structure. The tubular coils include a microwave generator positioned adjacent to them. The water heater includes an insulation member that positions around the tubular coils. The tubular coils connect to an outlet pipe. The inlet pipe supplies cold water to the tubular coils.

The microwave generator produces microwave energy directed at the tubular coils. Here, due to the overlapping pyramid shape of the tubular coils, each tubular coil on the inside has direct exposure to the microwave energy and each tubular coil on the outer side receives the microwave radiation after it penetrates through the inner coil and heats up the water. Further, the insulation member reflects back the microwave energy into the tubular coils and ensures there is no loss of energy.

After heating, the hot water flows through the outlet pipe. The water heater includes a pressure relief valve and a switch at the outlet pipe. The pressure relief valve keeps the internal pressure of the outlet pipe from getting too high. The switch operates in conjunction with the microwave generator and ensures the microwave generator is turned ON only when water is present in the tubular coils.

In one advantageous feature of the present invention, the water heater provides a tightly coiled tube arrangement wrapped one coil overlapping the other coil in a pyramid type shape. The wide end of the pyramid shaped tubular coils is where a variable air-cooled microwave generator of about 2000 watts with a wave guide introduces the energy. Here, the frequency of the microwave generator is the same as a microwave oven used in kitchens where the length of the microwave itself is close to the molecular size of the water molecule for the most efficient heating.

In another advantageous feature of the present invention, the water heater can be manufactured using three-dimensional (3D) printing or additive manufacturing process. 3D printing ensures the tubular coils can be manufactured with minimum diameter, e.g., one (1) diameter.

Features and advantages of the invention hereof will become more apparent in light of the following detailed description of selected embodiments, as illustrated in the accompanying FIGURE. As will be realised, the invention disclosed is capable of modifications in various respects, all without departing from the scope of the invention. Accordingly, the drawings and the description are to be regarded as illustrative in nature.

### BRIEF DESCRIPTION OF THE DRAWINGS

Further features and advantages of the present invention will become apparent from the following detailed description, taken in combination with the appended drawing, in which:

FIG. 1 illustrates a schematic diagram of a water heater, in accordance with one embodiment of the present invention.

It will be noted that throughout the appended drawings, like features are identified by like reference numerals.

### DETAILED DESCRIPTION OF THE EMBODIMENTS

Before the present features and working principle of a water heater is described, it is to be understood that this invention is not limited to the particular device as described, since it may vary within the specification indicated. Various features of a water heater might be provided by introducing variations within the components/subcomponents disclosed herein. It is also to be understood that the terminology used in the description is for the purpose of describing the particular versions or embodiments only, and is not intended to limit the scope of the present invention, which will be limited only by the appended claims. The words “comprising,” “having,” “containing,” and “including,” and other forms thereof, are intended to be equivalent in meaning and be open-ended in that an item or items following any one of these words is not meant to be an exhaustive listing of such item or items, or meant to be limited to only the listed item or items.

It should be understood that the present invention describes a water heater and a method of heating water utilizing microwave energy. The water heater includes an inlet pipe connecting tubular coils. The tubular coils overlap over one another in a pyramid-shape structure. The tubular coils include a microwave generator positioned adjacent to them. The water heater includes an insulation member that positions around the tubular coils. The tubular coils connect to an outlet pipe including a pressure relief valve and a switch. The inlet pipe supplies cold water to the tubular coils. The microwave generator produces microwave energy directed at the tubular coils. The microwave energy penetrates into the tubular coils and heats up the water. Further, the insulation member reflects back the microwave energy into the tubular coils and ensures there is no loss of energy. After heating, the hot water flows through the outlet pipe.

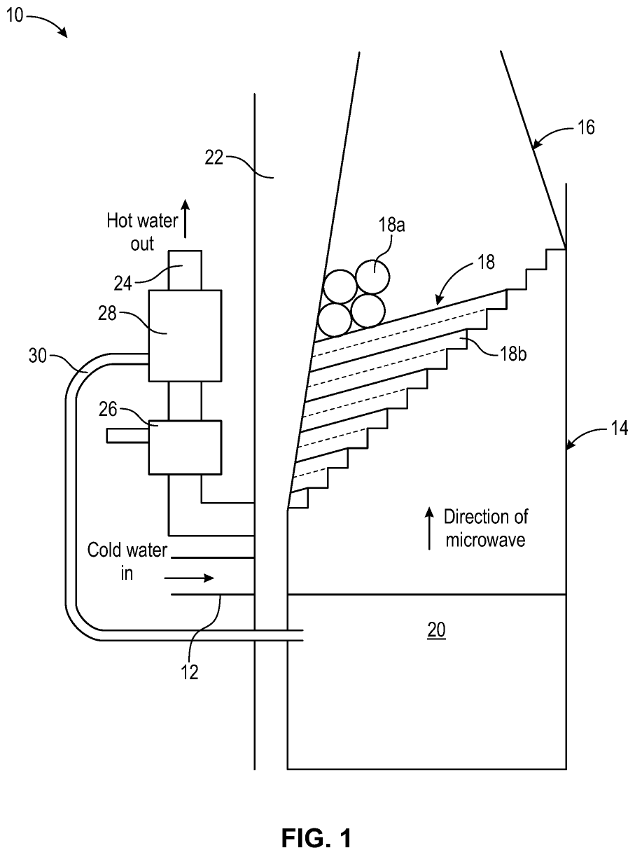

Various features and embodiments of a water heater for heating water utilizing microwave energy are explained in conjunction with the description of FIG. 1.

FIG. 1 shows a schematic diagram of a water heater 10, in accordance with one embodiment of the present invention. Water heater 10 includes an inlet pipe 12. Inlet pipe 12 provides a material made of metal, plastic or any other suitable material. Water heater 10 includes a housing 14 made of metal, plastic or any other suitable material. Housing 14 comes in a variety of shapes and sizes depending on the need. Housing 14 encompasses a tube enclosure 16. Tube enclosure 16 provides a material made of metal, plastic or any other suitable material. Tube enclosure 16 encompasses tubular coils 18 wrapped over one another in a pyramid-shape structure. In other words, tube enclosure 16 encompasses tubular coils 18 tightly wrapped, in which one coil overlaps over the other coil in a pyramid type shape. Tubular coils 18 provide a material made of cross-linked polyethylene (PEX, XPE or XLPE) or any other suitable material. In FIG. 1, 18a indicates a cross-section of tubular coils 18 and 18b indicates a side view of circular tubes inside tube enclosure 16, in accordance with one exemplary embodiment of the present invention.

Each of tubular coils 18 has a diameter of about one (1) inch. However, it is possible to select tubular coils 18 having different diameter(s) depending on the need. As can be seen from FIG. 1, tubular coils 18 position in such a way that outer tubular coil 18 fits into the vee created by inner tubular coil 18.

Further, housing 14 includes a microwave generator 20. Microwave generator 20 uses about 2000 watts with a wave guide to introduce the energy. In one example, microwave generator 20 includes asolid state microwave generator, air-cooled, variable frequency, automatic tuning, etc. Microwave generator 20 positions adjacent to tube enclosure 16 containing tubular coils 18. The wide end of the pyramid shape (about 6 inches in diameter) tubular coils 18 locates adjacent to microwave generator 20. Here, microwave generator 20 produces microwave energy and due to its position, the microwave energy is directed (direction of microwave) towards tubular coils 18.

Further, water heater 10 includes an insulation member 22. Insulation member 22 positions around pyramid-shaped tubular coils 18. Insulation member 22 provides a material that acts as an insulation and/or reflector of microwave energy. In one example, insulation member 22 includes a material such as Z steel-steel foam. Insulation member 22 reflects the microwave energy produced by microwave generator 20 back into tubular coils 18 and prevents heat loss.

Tubular coils 18 connect to an outlet pipe 24. Outlet pipe 24 provides a material made of metal, plastic or any other suitable material. Outlet pipe 24 extends and connects to external water dispensing mechanisms such as a water tap or shower, for example. At outlet pipe 24, water heater 10 includes a pressure relief valve 26. Pressure relief valve 26 helps to keep the internal pressure of outlet pipe 24 from getting too high. Further, water heater 10 includes a switch 28. In one example, switch 28 installs at the end of outlet pipe 24. Switch 28 indicates a water switch with an adjustable thermostat, such as a Negative Temperature Coefficient (NTC) Thermistor, for example. Switch 28 presents a control wire 30 that connects to microwave generator 20. Switch 28 sends a signal to microwave generator 20 via control wire 30 such that microwave generator 20 powers ON and/or operates only when water is present in tubular coils 18 and/or when demanded. Further, switch 28 determines the desired temperature of water and regulates the strength of microwave generator 20.

In operation, inlet pipe 12 receives water (cold or room temperature water) from a water supply source such as an overhead tank, for example. Water flows into tubular coils 18. When the water is in tubular coils 18, microwave generator 20 powers ON. As presented above, microwave generator 20 positions adjacent to tube enclosure 16 containing tubular coils 18. Microwave generator 20 produces microwave energy that is directed towards tubular coils 18. The microwave energy penetrates into tubular coils 18. In one example, the microwave energy has a penetration depth of about one (1) inch. Here, due to the overlapping pyramid shape of tubular coils 18, each tubular coil 18 on the inside has direct exposure to the microwave energy and each tubular coil 18 on the outer side receives the microwave radiation after it penetrates through the inner coil and into the water. In one example, the frequency of microwave generator 20 is configured to be the same as a microwave oven used in kitchens where the length of the microwave itself is close to the molecular size of the water molecule for the most efficient heating. This results in heating of the water inside tubular coils 18.

As presented above, insulation member 22 positions around pyramid-shaped tubular coils 18. When microwave generator 20 produces microwave energy, the microwave energy hits insulation member 22 gets reflected back into tubular coils 18. This ensures the microwave energy is used to heat the tubular coils 18 and the water inside tubular coils 18 and there is no loss of energy/heat.

After the water gets heated, the hot water flows out of tubular coils 18 through outlet pipe 24. As presented above, outlet pipe 24 includes pressure relief valve 26 and switch 28. Pressure relief valve 26 keeps the internal pressure of outlet pipe 24 from getting too high. Switch 28 works in conjunction with microwave generator 20 and ensures microwave generator 20 is turned ON only when water is present in tubular coils 12. Further, switch 28 ensures that the desired temperature is set to regulate the strength of microwave generator 20.

In one example, the presently disclosed water heater is manufactured using a three-dimensional (3D) printing or additive manufacturing process. 3D printing ensures the tubular coils are manufactured with minimum diameter, e.g., one (1) inch diameter. When compared with traditional tubular coils, they come in large diameter, say about ten (10) inches. Use of traditional coils increases the size of the pyramid shape structure of tubular coils. As such, the traditional coils are not desirable for use in pyramid shape structure.

The presently disclosed water heater presents several advantages. For example, the presently disclosed water heater can be used to heat water for domestic and light industrial use. The water heater can be manufactured using a 3D printing process. As such, the construction cost is lower than current water tanks or water heaters. The 3D printing process allows to manufacture identical units in a much shorter time. This reduces the number of parts needed to assemble to make a water heater. The water heater operates and consumes electricity only for heating while the water is demanded. This increases the electricity savings of at least 33% per year or more when compared to existing water tanks/heaters.

The presently disclosed water heater requires only a longer inlet pipe to receive the cold water. The water heater can be installed where the water is used. Further, the water heater requires no drainage, very little calcium build-up, no corrosion of inner pipes, takes up less space, etc. The water heater provides usage in large buildings such as hotels and motels and office buildings. The presently disclosed water heater provides as much hot water to a house as the current tank (dishwater, clothes washer, showers, sinks) and never runs short.

A person skilled in the art appreciates that the water heater may come in a variety of sizes depending on the need and comfort of the user. Further, different materials in addition to or instead of materials described herein may also be used and such implementations may be construed to be within the scope of the present invention. Further, many changes in the design and placement of components may take place without deviating from the scope of the presently disclosed water heater.

In the above description, numerous specific details are set forth such as examples of some embodiments, specific components, devices, methods, in order to provide a thorough understanding of embodiments of the present invention. It will be apparent to a person of ordinary skill in the art that these specific details need not be employed, and should not be construed to limit the scope of the invention.

In the development of any actual implementation, numerous implementation-specific decisions must be made to achieve the developer's specific goals, such as compliance with system-related and business-related constraints. Such a development effort might be complex and time-consuming, but may nevertheless be a routine undertaking of design, fabrication, and manufacture for those of ordinary skill. Hence as various changes could be made in the above constructions without departing from the scope of the invention, it is intended that all matter contained in the above description or shown in the accompanying drawings shall be interpreted as illustrative and not in a limiting sense.

The foregoing description of embodiments is provided to enable any person skilled in the art to make and use the invention. Various modifications to these embodiments will be readily apparent to those skilled in the art, and the novel principles and invention disclosed herein may be applied to other embodiments without the use of the innovative faculty. It is contemplated that additional embodiments are within the spirit and true scope of the disclosed invention.

What is claimed is:

1. A water heater, comprising:
an inlet pipe;
a housing comprising a tube enclosure;
tubular coils encompassed in said tube enclosure, wherein said tubular coils are wrapped over one another in a pyramid-shape structure;
a microwave generator positioned adjacent to said tube enclosure; and
an insulation member positioned around said tubular coils,
wherein said inlet pipe receives and supplies water into said tubular coils,
wherein said microwave generator produces microwave energy that is directed towards said tubular coils, and
wherein said microwave energy hits said insulation member and gets reflected back into said tubular coils heating the water inside said tubular coils and prevents heat loss.

2. The water heater of claim 1, further comprises an outlet pipe, wherein said outlet pipe connects to said tubular coils.

3. The water heater of claim 2, wherein said outlet pipe connects to an external water dispensing mechanism.

4. The water heater of claim 2, wherein said outlet pipe comprises a pressure relief valve, and wherein said pressure relief valve keeps the internal pressure of said outlet pipe from getting too high.

5. The water heater of claim 2, wherein said outlet pipe comprises a switch, and wherein said switch electrically connects to said microwave generator via a control wire.

6. The water heater of claim 5, wherein said switch sends a signal to said microwave generator via said control wire such that said microwave generator powers ON or operates only when the water is present in said tubular coils.

7. The water heater of claim 6, wherein said switch determines a desired temperature of the water and regulates the strength of said microwave generator.

8. The water heater of claim 1, wherein said inlet pipe receives the water from a water supply source.

9. The water heater of claim 1, wherein said microwave generator produces said microwave energy having a penetration depth of about one inch.

10. The water heater of claim 1, wherein said pyramid-shape structure of said tubular coils allows each tubular coil on the inside to have direct exposure to said microwave energy and each tubular coil on the outer side receives said microwave energy after it penetrates through said tubular coil on the inside and into the water.

11. The water heater of claim 1, wherein said tubular coils are positioned such that the wide end of said pyramid-shape structure locates adjacent to said microwave generator.

12. A method of heating water, the method comprising the steps of:
providing an inlet pipe;
providing a housing comprising a tube enclosure;
providing tubular coils encompassed in said tube enclosure, said tubular coils wrapped over one another in a pyramid-shape structure;
providing a microwave generator positioned adjacent to said tube enclosure;
providing an insulation member positioned around said tubular coils;
receiving water in said inlet pipe;
supplying the water into said tubular coils;
directing microwave energy produced by said microwave generator towards said tubular coils; and
allowing said microwave energy to hit and reflect back from said insulation member and into said tubular coils for heating the water inside said tubular coils and preventing heat loss.

13. The method of claim 12, further comprising providing an outlet pipe connecting to said tubular coils, said outlet pipe connecting to an external water dispensing mechanism.

14. The method of claim 13, further comprising providing a pressure relief valve at said outlet pipe, said pressure relief valve capable of keeping the internal pressure of said outlet pipe from getting too high.

15. The method of claim 12, further comprising providing a switch at said outlet pipe, said switch electrically connecting to said microwave generator via a control wire.

16. The method of claim 15, further comprising sending a signal by said switch to said microwave generator via said control wire such that said microwave generator powers ON or operates only when the water is present in said tubular coils.

17. The method of claim 16, further comprising configuring said switch for determining a desired temperature of the water and regulating the strength of said microwave generator.

18. The method of claim 12, further comprising configuring said microwave generator to produce said microwave energy having a penetration depth of about one inch.

19. The method of claim 12, further comprising configuring said pyramid-shape structure of said tubular coils such that each tubular coil on the inside has direct exposure to said microwave energy and each tubular coil on the outer side receives said microwave radiation after it penetrates through said tubular coil on the inside and into the water.

20. The method of claim 12, further comprising positioning said tubular coils such that the wide end of said pyramid-shape structure locates adjacent to said microwave generator.
